(19) United States
(12) Patent Application Publication
(10) Pub. No.: US 2026/0205785 A1
(43) Pub. Date: Jul. 16, 2026

(54) Bluetooth peripheral apparatus, Bluetooth central apparatus and Bluetooth communication method having dynamic bandwidth allocation mechanism

(71) Applicant: REALTEK SEMICONDUCTOR CORPORATION, Hsinchu (TW)

(72) Inventors: CHIH-WEI HO, Hsinchu (TW); Yu-Nung Wei, Hsinchu (TW); Yu Chiang, Hsinchu (TW)

(21) Appl. No.: 19/443,369

(22) Filed: Jan. 8, 2026

(30) Foreign Application Priority Data
Jan. 14, 2025 (TW) 114101548

(51) Int. Cl. H04W 4/80

(52) U.S. Cl. CPC H04W 4/80

(57) ABSTRACT

A Bluetooth communication method having dynamic bandwidth allocation mechanism is provided including steps outlined below. A Bluetooth central apparatus and a Bluetooth peripheral apparatus perform a CIS communication according to a CIS technology. The Bluetooth central apparatus performs normal transmission mode packet communication behaviors with the Bluetooth peripheral apparatus operating under a normal transmission mode such that the Bluetooth peripheral apparatus performs an ACK signal transmission behavior in response. The Bluetooth central apparatus performs high bandwidth transmission mode packet communication behaviors with the Bluetooth peripheral apparatus operating under a high bandwidth transmission mode such that the Bluetooth peripheral apparatus selects at least one selected high bandwidth transmission mode packet communication behaviors and does not perform the ACK signal transmission behavior corresponding to the selected high bandwidth transmission mode packet communication behaviors.

### BACKGROUND OF THE INVENTION

### 1. Field of the Invention

The present invention relates to a Bluetooth peripheral apparatus, a Bluetooth central apparatus and a Bluetooth communication method having a dynamic bandwidth allocation mechanism.

### 2. Description of Related Art

Bluetooth is a wireless communication technology standard to allow a fixed apparatus and a mobile apparatus to exchange data within a short distance to form a personal area network (PAN). Connected Isochronous Stream (CIS) technology is a Bluetooth Low Energy (LE) audio technology developed on the basis of the Bluetooth technology standard to allow Bluetooth peripheral apparatuses in a Connected Isochronous Group (CIG) to receive the audio signal from a Bluetooth central apparatus in a synchronous manner.

However, in the current configuration of the technology, each of the Bluetooth peripheral apparatuses is required to transmit an acknowledgement signal in response to the data transmitted by the Bluetooth central apparatus. Not only a large amount of power is dissipated, but also the bandwidth of data transmission is occupied.

### SUMMARY OF THE INVENTION

In consideration of the problem of the prior art, an object of the present invention is to supply a Bluetooth peripheral apparatus, a Bluetooth central apparatus and a Bluetooth communication method having a dynamic bandwidth allocation mechanism.

The present invention discloses a Bluetooth peripheral apparatus having a dynamic bandwidth allocation mechanism that includes a communication circuit and a processing circuit. The processing circuit is electrically coupled to the communication circuit and is configured to perform steps outlined below. A connected isochronous stream (CIS) communication is performed through the communication circuit with a Bluetooth central apparatus by using a CIS technology. A normal transmission mode is operated to perform an acknowledgement (ACK) signal transmission behavior corresponding to each of a plurality of normal transmission mode packet communication behaviors performed with the Bluetooth central apparatus. A high bandwidth transmission mode is operated to select at least one selected high bandwidth transmission mode packet communication behavior from a plurality of high bandwidth transmission mode packet communication behaviors performed with the Bluetooth central apparatus and not perform the ACK signal transmission behavior corresponding to the at least one selected high bandwidth transmission mode packet communication behavior.

The present invention also discloses a Bluetooth central apparatus having a dynamic bandwidth allocation mechanism that includes a communication circuit and a processing circuit. The processing circuit is electrically coupled to the communication circuit and is configured to perform steps outlined below. A CIS communication is performed through the communication circuit with a Bluetooth peripheral apparatus by using a CIS technology. A plurality of normal transmission mode packet communication behaviors are performed with the Bluetooth peripheral apparatus operated in a normal transmission mode to request the Bluetooth peripheral apparatus to perform an ACK signal transmission behavior corresponding to each of a plurality of normal transmission mode packet communication behaviors. A plurality of high bandwidth transmission mode packet communication behaviors are performed with the Bluetooth peripheral apparatus operated in a high bandwidth transmission mode to select at least one selected high bandwidth transmission mode packet communication behavior from a plurality of high bandwidth transmission mode packet communication behaviors to stop requesting the Bluetooth peripheral apparatus to perform the ACK signal transmission behavior corresponding to the at least one selected high bandwidth transmission mode packet communication behavior.

The present invention further discloses a Bluetooth communication method having a dynamic bandwidth allocation mechanism that includes steps outlined below. A CIS communication is performed between a Bluetooth central apparatus and a Bluetooth peripheral apparatus by using a CIS technology. A plurality of normal transmission mode packet communication behaviors are performed between the Bluetooth central apparatus and the Bluetooth peripheral apparatus operated in a normal transmission mode such that the Bluetooth peripheral apparatus performs an ACK signal transmission behavior corresponding to each of the normal transmission mode packet communication behaviors. A plurality of high bandwidth transmission mode packet communication behaviors are performed between the Bluetooth central apparatus and the Bluetooth peripheral apparatus operated in a high bandwidth transmission mode such that the Bluetooth peripheral apparatus selects at least one selected high bandwidth transmission mode packet communication behavior from the high bandwidth transmission mode packet communication behaviors and does not perform the ACK signal transmission behavior corresponding to the at least one selected high bandwidth transmission mode packet communication behavior.

These and other objectives of the present invention will no doubt become obvious to those of ordinary skill in the art behind reading the following detailed description of the preferred embodiments that are illustrated in the various figures and drawings.

### BRIEF DESCRIPTION OF THE DRAWINGS

FIG. 1 illustrates a block diagram of a Bluetooth communication system according to an embodiment of the present invention.

FIG. 2 illustrates a signal timing diagram of the communication performed by the Bluetooth central apparatus with the Bluetooth peripheral apparatus and the Bluetooth peripheral apparatus operating in the normal transmission mode according to an embodiment of the present invention.

FIG. 3 illustrates a signal timing diagram of the communication performed by the Bluetooth central apparatus with the Bluetooth peripheral apparatus and the Bluetooth peripheral apparatus operating in the high bandwidth transmission mode according to an embodiment of the present invention.

FIG. 4 illustrates a signal timing diagram of the communication performed by the Bluetooth central apparatus with the Bluetooth peripheral apparatus operating in the high bandwidth transmission mode and the Bluetooth peripheral apparatus operating in the normal transmission mode according to an embodiment of the present invention.

FIG. 5 illustrates a signal timing diagram of the communication performed by the Bluetooth central apparatus with the Bluetooth peripheral apparatus operating in the normal transmission mode and the Bluetooth peripheral apparatus operating in the high bandwidth transmission mode according to an embodiment of the present invention.

FIG. 6 illustrates a flow chart of a Bluetooth communication method having a dynamic bandwidth allocation mechanism according to an embodiment of the present invention.

### DETAILED DESCRIPTION OF THE PREFERRED EMBODIMENTS

An aspect of the present invention is to provide a Bluetooth peripheral apparatus, a Bluetooth central apparatus and a Bluetooth communication method having a dynamic bandwidth allocation mechanism to allow the Bluetooth peripheral apparatus that operates in a high bandwidth transmission mode to not perform the acknowledgement signal transmission behavior to increase the data bandwidth between the Bluetooth central apparatus and the Bluetooth peripheral apparatus so as to accomplish the object of the increasing the data transmission amount or the power saving.

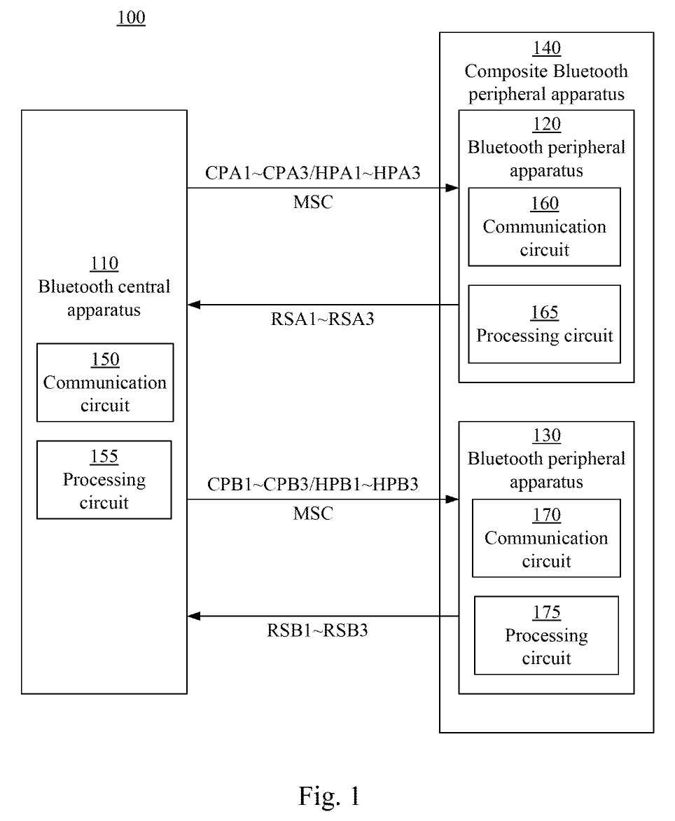

Reference is now made to FIG. 1. FIG. 1 illustrates a block diagram of a Bluetooth communication system 100 according to an embodiment of the present invention. The Bluetooth communication system 100 includes a Bluetooth central apparatus 110, a Bluetooth peripheral apparatus 120 and a Bluetooth peripheral apparatus 130.

The Bluetooth central apparatus 110, according to a Connected Isochronous Stream (CIS) technology, performs a CIS communication with the Bluetooth peripheral apparatus 120 and the Bluetooth peripheral apparatus 130.

In an embodiment, the Bluetooth central apparatus 110 is such as, but not limited to a smart phone, a tablet PC or other apparatuses that is able to provide an audio signal by using the CIS technology under the Bluetooth protocol.

In an embodiment, each of the Bluetooth peripheral apparatus 120 and the Bluetooth peripheral apparatus 130 is one of a plurality of sub-apparatuses included by a composite Bluetooth peripheral apparatus 140. The composite Bluetooth peripheral apparatus 140 is such as, but not limited to an earpiece, a speaker or other apparatuses that is able to receive the audio signal by using the CIS technology under the Bluetooth protocol such that the sub-apparatuses included therein together form a Connected Isochronous Group (CIG).

For example, when the composite Bluetooth peripheral apparatus 140 is the earpiece, two sub-apparatuses corresponding to the left ear and the right ear can be included to correspond to the Bluetooth peripheral apparatus 120 and the Bluetooth peripheral apparatus 130. In other embodiments, the number of the sub-apparatuses included by the composite Bluetooth peripheral apparatus 140 can be more than two. For example, when the composite Bluetooth peripheral apparatus 140 is a speaker, more than two sub-apparatuses corresponding to a multiple of sound channels can be included.

The Bluetooth central apparatus 110 includes a communication circuit 150 and a processing circuit 155. The processing circuit 155 is electrically coupled to the communication circuit 150 to perform the CIS communication with each of the Bluetooth peripheral apparatus 120 and the Bluetooth peripheral apparatus 130 in a one-to-one manner through the communication circuit 150.

The Bluetooth peripheral apparatus 120 includes a communication circuit 160 and a processing circuit 165. The processing circuit 165 is electrically coupled to the communication circuit 160 to perform the CIS communication with the Bluetooth central apparatus 110 in a one-to-one manner through the communication circuit 160. The Bluetooth peripheral apparatus 130 includes a communication circuit 170 and a processing circuit 175. The processing circuit 175 is electrically coupled to the communication circuit 170 to perform the CIS communication with the Bluetooth central apparatus 110 in a one-to-one manner through the communication circuit 170.

Each of the Bluetooth peripheral apparatus 120 and the Bluetooth peripheral apparatus 130 may operate in a normal transmission mode such that the Bluetooth central apparatus 110 performs communication with the Bluetooth peripheral apparatus 120 and the Bluetooth peripheral apparatus 130 operating in the normal transmission mode according to the CIS technology. The description of the operation of the Bluetooth central apparatus 110, the Bluetooth peripheral apparatus 120 and the Bluetooth peripheral apparatus 130 in the following paragraphs can be performed by the processing circuits in these apparatuses through the use of the communication circuits therein.

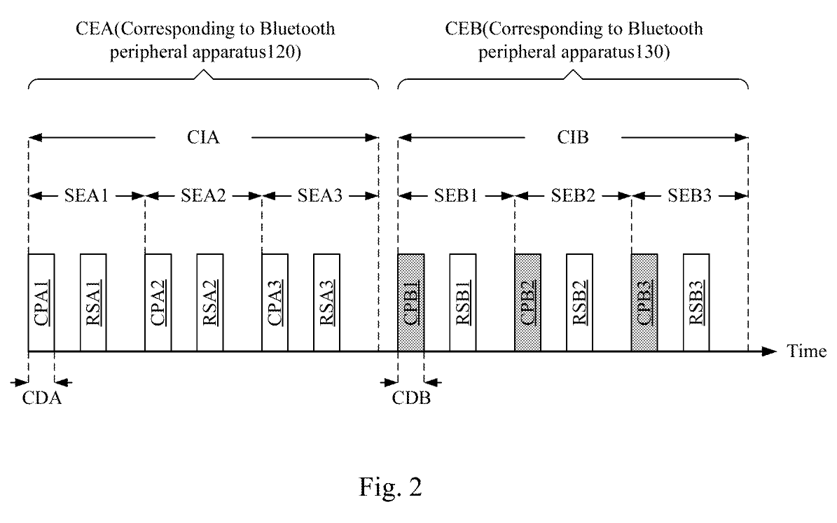

Reference is now made to FIG. 2. FIG. 2 illustrates a signal timing diagram of the communication performed by the Bluetooth central apparatus 110 with the Bluetooth peripheral apparatus 120 and the Bluetooth peripheral apparatus 130 operating in the normal transmission mode according to an embodiment of the present invention. In FIG. 2, the X-axis stands for time.

The Bluetooth central apparatus 110 perform a plurality of normal transmission mode packet communication behaviors CPA1~CPA3 illustrated as white blocks with the Bluetooth peripheral apparatus 120 that operates in the normal transmission mode to request the Bluetooth peripheral apparatus 120 to perform acknowledgement (ACK) signal transmission behavior RSA1~RSA3 corresponding to the normal transmission mode packet communication behaviors CPA1~CPA3. The normal transmission mode packet communication behaviors CPA1~CPA3 are performed by the Bluetooth central apparatus 110 to transmit packets to the Bluetooth peripheral apparatus 120 such that the Bluetooth peripheral apparatus 120 receives the packets. The packets transmitted can be such as, but not limited to audio data packets.

In an embodiment, each of the normal transmission mode packet communication behaviors CPA1~CPA3 corresponds to one of a plurality of subevents SEA1~SEA3 in a CIS interval CIA of a CIS event CEA in a one-to-one manner. The subevent SEA1 is used to sequentially perform the normal transmission mode packet communication behavior CPA1 and the ACK signal transmission behavior RSA1. The subevent SEA2 is used to sequentially perform the normal transmission mode packet communication behavior CPA2 and the ACK signal transmission behavior RSA2. The subevent SEA3 is used to sequentially perform the normal transmission mode packet communication behavior CPA3 and the ACK signal transmission behavior RSA3. In an embodiment, each group of the normal transmission mode packet communication behavior and ACK signal transmission behavior may include a reserved time gap TIFS therebetween and may not be disposed in a close manner.

In an embodiment, the ACK signal transmission behavior has a time length of 44 microseconds (µs) and the reserved time gap TIFS has a time length of 150 microseconds.

Similarly, the Bluetooth central apparatus 110 performs a plurality of normal transmission mode packet communication behaviors CPB1~CPB3 illustrated as gray blocks with the Bluetooth peripheral apparatus 130 that operates in the normal transmission mode to request the Bluetooth peripheral apparatus 130 to perform ACK signal transmission behavior RSB1~RSB3 corresponding to the normal transmission mode packet communication behaviors CPB1~CPB3. The normal transmission mode packet communication behaviors CPB1~CPB3 are performed by the Bluetooth central apparatus 110 to transmit packets to the Bluetooth peripheral apparatus 130 such that the Bluetooth peripheral apparatus 130 receives the packets. The packets transmitted can be such as, but not limited to audio data packets.

In an embodiment, each of the normal transmission mode packet communication behaviors CPB1~CPB3 corresponds to one of a plurality of subevents SEB1~SEB3 in a CIS interval CIB of a CIS event CEB in a one-to-one manner. The subevent SEB1 is used to sequentially perform the normal transmission mode packet communication behavior CPB1 and the ACK signal transmission behavior RSB1. The subevent SEB2 is used to sequentially perform the normal transmission mode packet communication behavior CPB2 and the ACK signal transmission behavior RSB2. The subevent SEB3 is used to sequentially perform the normal transmission mode packet communication behavior CPB3 and the ACK signal transmission behavior RSB3.

On the other hand, in order to allow the Bluetooth central apparatus 110 to perform data transmission under a higher bandwidth condition with the Bluetooth peripheral apparatus 120 and the Bluetooth peripheral apparatus 130, the Bluetooth central apparatus 110, the Bluetooth peripheral apparatus 120 and the Bluetooth peripheral apparatus 130 may have a dynamic bandwidth allocation mechanism to allow the Bluetooth peripheral apparatus 120 and the Bluetooth peripheral apparatus 130 to operate in a high bandwidth transmission mode such that the Bluetooth central apparatus 110 performs communication with the Bluetooth peripheral apparatus 120 and the Bluetooth peripheral apparatus 130 in the high bandwidth transmission mode according to the CIS technology.

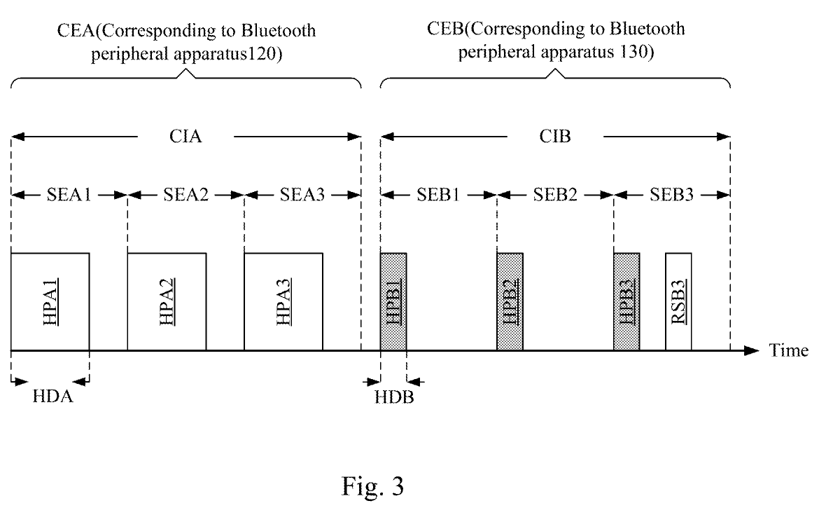

Reference is now made to FIG. 3. FIG. 3 illustrates a signal timing diagram of the communication performed by the Bluetooth central apparatus 110 with the Bluetooth peripheral apparatus 120 and the Bluetooth peripheral apparatus 130 operating in the high bandwidth transmission mode according to an embodiment of the present invention. In FIG. 3, the X-axis stands for time.

The Bluetooth central apparatus 110 perform a plurality of high bandwidth transmission mode packet communication behaviors HPA1~HPA3 illustrated as white blocks with the Bluetooth peripheral apparatus 120 that operates in the high bandwidth transmission mode to select at least one selected high bandwidth transmission mode packet communication behavior from the high bandwidth transmission mode packet communication behaviors HPA1~HPA3 to stop requesting the Bluetooth peripheral apparatus 120 to perform the ACK signal transmission behavior corresponding to the at least one selected high bandwidth transmission mode packet communication behavior.

On the other hand, according to the behavior of “stop requesting” from the Bluetooth central apparatus 110, the Bluetooth peripheral apparatus 120 selects at least one selected high bandwidth transmission mode packet communication behavior from the high bandwidth transmission mode packet communication behaviors HPA1~HPA3 and does not perform the ACK signal transmission behavior corresponding to the selected high bandwidth transmission mode packet communication behavior.

The high bandwidth transmission mode packet communication behaviors HPA1~HPA3 are performed by the Bluetooth central apparatus 110 to transmit packets to the Bluetooth peripheral apparatus 120 such that the Bluetooth peripheral apparatus 120 receives the packets. The packets transmitted can be such as, but not limited to audio data packets. In the present embodiment, the selected high bandwidth transmission mode packet communication behaviors are the high bandwidth transmission mode packet communication behaviors HPA1~HPA3.

In an embodiment, similar to the normal transmission mode packet communication behaviors CPA1~CPA3, each of the high bandwidth transmission mode packet communication behaviors HPA1~HPA3 corresponds to one of the subevents SEA1~SEA3 in the CIS interval CIA of the CIS event CEA in a one-to-one manner. As a result, the subevent SEA1 only includes the high bandwidth transmission mode packet communication behavior HPA1. The subevent SEA2 only includes the high bandwidth transmission mode packet communication behavior HPA2. The subevent SEA3 only includes the high bandwidth transmission mode packet communication behavior HPA3.

In the present embodiment, a first data amount included by each of the selected high bandwidth transmission mode packet communication behaviors (e.g., the high bandwidth transmission mode packet communication behaviors HPA1~HPA3) is larger than a second data amount included by each of the normal transmission mode packet communication behaviors (e.g., the normal transmission mode packet communication behaviors CPA1~CPA3 in FIG. 2). The first data amount in each of the selected high bandwidth transmission mode packet communication behaviors is labeled as the data amount HDA in FIG. 3. The second data amount of each of the normal transmission mode packet communication behaviors is labeled as the data amount CDA in FIG. 2.

As a result, under the condition that the Bluetooth central apparatus 110 does not need to receive the ACK signal from the Bluetooth peripheral apparatus 120, the Bluetooth central apparatus 110 may allocate the bandwidth originally allocated to the ACK signal transmission behaviors to the selected high bandwidth transmission mode packet communication behaviors, to allow each of the selected high bandwidth transmission mode packet communication behaviors includes a larger data amount. By using such a dynamic bandwidth allocation mechanism, the Bluetooth central apparatus 110 may transmit the audio signal with a quality higher than that in the normal transmission mode through the selected high bandwidth transmission mode packet communication behaviors in the high bandwidth transmission mode.

More specifically, one selected high bandwidth transmission mode packet communication behavior may additionally use the time length that is the sum of one ACK signal transmission behavior (44 microseconds) and one reserved time gap TIFS (150 microseconds), which is 194 microseconds. When a physical layer circuit having the speed of 2 Mbps is used in the Bluetooth central apparatus 110, an additional data amount of (194×2)/8=48.5 MB. Under the condition that the encoding configuration of 32K 32_1_1 in the LCS low delay audio coding technology, i.e., the service data unit (SDU) is 60 byes and an interval is 7.5 millisecond (ms), the communication circuit 150 in the Bluetooth central apparatus 110 may additionally transmit 48/60=80% of data amount such that an audio signal of the high quality implemented by the encoding configuration of 48k 48_3_1, i.e., the SDU is 90 byes and an interval is 7.5 millisecond, can be transmitted.

Similarly, the Bluetooth central apparatus 110 perform a plurality of high bandwidth transmission mode packet communication behaviors HPB1~HPB3 illustrated as gray blocks with the Bluetooth peripheral apparatus 130 that operates in the high bandwidth transmission mode to select at least one selected high bandwidth transmission mode packet communication behavior from the high bandwidth transmission mode packet communication behaviors HPB1~HPB3 to stop requesting the Bluetooth peripheral apparatus 130 to perform the ACK signal transmission behavior corresponding to the at least one selected high bandwidth transmission mode packet communication behavior.

On the other hand, according to the behavior of “stop requesting” from the Bluetooth central apparatus 110, the Bluetooth peripheral apparatus 130 selects at least one selected high bandwidth transmission mode packet communication behavior from the high bandwidth transmission mode packet communication behaviors HPB1~HPB3 and does not perform the ACK signal transmission behavior corresponding to the selected high bandwidth transmission mode packet communication behavior.

The high bandwidth transmission mode packet communication behaviors HPB1~HPB3 are performed by the Bluetooth central apparatus 110 to transmit packets to the Bluetooth peripheral apparatus 130 such that the Bluetooth peripheral apparatus 130receives the packets. The packets transmitted can be such as, but not limited to audio data packets. In the present embodiment, the selected high bandwidth transmission mode packet communication behaviors are the high bandwidth transmission mode packet communication behaviors HPB1~HPB2.

In an embodiment, similar to the normal transmission mode packet communication behaviors CPB1~CPB3, each of the high bandwidth transmission mode packet communication behaviors HPB1~HPB3 corresponds to one of the subevents SEB1~SEB3 in the CIS interval CIB of the CIS event CEB in a one-to-one manner. As a result, the subevent SEB1 only includes the high bandwidth transmission mode packet communication behavior HPB1. The subevent SEB2 only includes the high bandwidth transmission mode packet communication behavior HPB2. Since the high bandwidth transmission mode packet communication behavior HPB3 is not the selected high bandwidth transmission mode packet communication behavior, the subevent SEB3 includes the high bandwidth transmission mode packet communication behavior HPB3 and the ACK signal transmission behavior RSB3.

In the present embodiment, a first data amount included by each of the selected high bandwidth transmission mode packet communication behaviors (e.g., the high bandwidth transmission mode packet communication behaviors HPB1~HPB2) equals to a second data amount included by each of the normal transmission mode packet communication behaviors (e.g., the normal transmission mode packet communication behaviors CPB1~CPB2 in FIG. 2). The first data amount in each of the selected high bandwidth transmission mode packet communication behaviors is labeled as the data amount HDB in FIG. 3. The second data amount of each of the normal transmission mode packet communication behaviors is labeled as the data amount CD in FIG. 2.

As a result, under the condition that the Bluetooth central apparatus 110 does not need to receive the ACK signal from the Bluetooth peripheral apparatus 130, the Bluetooth central apparatus 110 may not perform any operation on the bandwidth originally allocated to the ACK signal transmission behaviors and only requests the Bluetooth peripheral apparatus 130 to perform the ACK signal transmission behavior RSB3 in the subevent SEB3 to acknowledge the receiving of the signal. By using such a dynamic bandwidth allocation mechanism, the Bluetooth central apparatus 110 and the Bluetooth peripheral apparatus 130 may accomplish a power-saving mechanism in the high bandwidth transmission mode that dissipates less power than the normal transmission mode.

More specifically, each time the communication circuit 150 of the Bluetooth central apparatus 110 does not perform signal receiving in the time slot corresponding to the ACK signal transmission behavior, a power of 1.03 micro coulomb (µC) that is 16.6% of the power dissipated in the normal transmission mode can be saved. Each time the communication circuit 150 of the Bluetooth peripheral apparatus 130 does not perform signal transmitting in the time slot corresponding to the ACK signal transmission behavior, a power of 3.17 micro coulomb that is 25% of the power dissipated in the normal transmission mode can be saved.

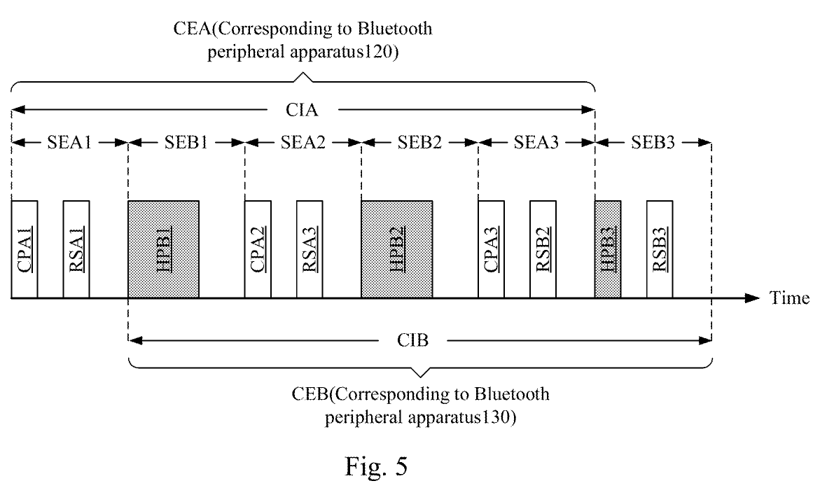

It is appreciated that the composite Bluetooth peripheral apparatus 140 can be configured such that a first part of the sub-apparatuses included therein operate in the high bandwidth transmission mode and a second part of the sub-apparatuses included therein operate in either the high bandwidth transmission mode or the normal transmission mode. In the embodiment of FIG. 5, the condition that both of the Bluetooth peripheral apparatus 120 and the Bluetooth peripheral apparatus 130 in the composite Bluetooth peripheral apparatus 140 operate in the high bandwidth transmission mode is used as an example. In other embodiments, the composite Bluetooth peripheral apparatus 140 may be configured such that the Bluetooth peripheral apparatus 120 operates in the high bandwidth transmission mode and the Bluetooth peripheral apparatus 130 operates in the normal transmission mode.

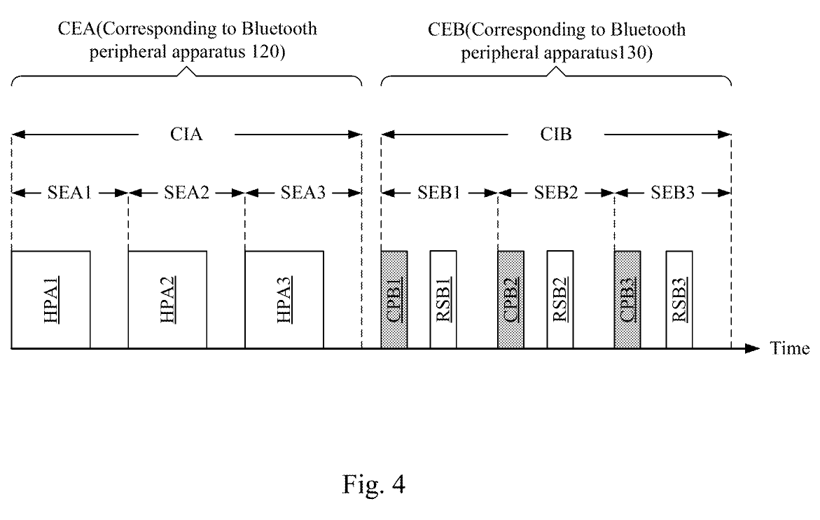

Reference is now made to FIG. 4. FIG. 4 illustrates a signal timing diagram of the communication performed by the Bluetooth central apparatus 110 with the Bluetooth peripheral apparatus 120 operating in the high bandwidth transmission mode and the Bluetooth peripheral apparatus 130 operating in the normal transmission mode according to an embodiment of the present invention. In FIG. 4, the X-axis stands for time.

In FIG. 4, the signal timing of the Bluetooth peripheral apparatus 120 operating in the high bandwidth transmission mode is actually the same as that in FIG. 3. The signal timing of the Bluetooth peripheral apparatus 130 operating in the normal transmission mode is actually the same as that in FIG. 2. The detail is not described herein.

By using the configuration that the Bluetooth peripheral apparatus 120 operates in the high bandwidth transmission mode and the Bluetooth peripheral apparatus 130 operates in the normal transmission mode, the Bluetooth central apparatus 110 may increase the data transmission amount by using the high bandwidth transmission mode and confirm the reception of the signal based on the ACK signal transmission behavior performed with the Bluetooth peripheral apparatus 130.

It is appreciated that the number of the high bandwidth transmission mode packet communication behaviors and the number of the selected high bandwidth transmission mode packet communication behavior included in one CIS event are merely an example. The present invention is not limited thereto.

In the embodiments of FIG. 3 and FIG. 4, the CIS events that the sub-apparatuses (i.e., the Bluetooth peripheral apparatus 120 and the Bluetooth peripheral apparatus 130) correspond to, which are the CIS event CEA and the CIS event CEB are arranged in a sequential manner. More specifically, the timing of the CIS event CEB is arranged behind the timing of the CIS event CEA such that the high bandwidth transmission mode packet communication behaviors HPA1~HPA3 are performed first and the high bandwidth transmission mode packet communication behaviors HPB1~HPB3 are performed subsequently.

In other embodiments, the CIS events that the sub-apparatuses included by the Bluetooth peripheral apparatus 140 correspond to are arranged in an interleaved manner such that K-th subevents of the CIS intervals of all the sub-apparatuses are arranged in a sequential manner, and K+1 subevents of the CIS intervals of all the sub-apparatuses are arranged in a sequential manner behind the K-th subevents of the CIS intervals of all the sub-apparatuses, in which K is an integer larger than 0.

Reference is now made to FIG. 5. FIG. 5 illustrates a signal timing diagram of the communication performed by the Bluetooth central apparatus 110 with the Bluetooth peripheral apparatus 120 operating in the normal transmission mode and the Bluetooth peripheral apparatus 130 operating in the high bandwidth transmission mode according to an embodiment of the present invention. In FIG. 5, the X-axis stands for time.

As illustrated in FIG. 5, the first subevent SEA1 in the CIS interval CIA that the Bluetooth peripheral apparatus 120 corresponds to and the first subevent SEB1 in the CIS interval CIB that the Bluetooth peripheral apparatus 130 corresponds to are arranged in a sequential manner.

The second subevent SEA2 in the CIS interval CIA that the Bluetooth peripheral apparatus 120 corresponds and the second subevent SEB2 in the CIS interval CIB that the Bluetooth peripheral apparatus 130 corresponds to are arranged in a sequential manner behind the subevent SEA1 and subevent SEB1.

The third subevent SEA3 in the CIS interval CIA that the Bluetooth peripheral apparatus 120 corresponds and the third subevent SEB3 in the CIS interval CIB that the Bluetooth peripheral apparatus 130 corresponds to are arranged in a sequential manner behind the subevent SEA2 and subevent SEB2.

In the present embodiment, the Bluetooth peripheral apparatus 120 operates in the normal transmission mode such that the subevent SEA1 includes the normal transmission mode packet communication behavior CPA1 and the ACK signal transmission behavior RSA1, the subevent SEA2 includes the normal transmission mode packet communication behavior CPA2 and the ACK signal transmission behavior RSA2, and the subevent SEA3 includes the normal transmission mode packet communication behavior CPA3 and the ACK signal transmission behavior RSA3.

In the present embodiment, the Bluetooth peripheral apparatus 130 operates in the high bandwidth transmission mode such that the subevent SEB1 only includes the high bandwidth transmission mode packet communication behavior HPB1, the subevent SEB2 only includes the high bandwidth transmission mode packet communication behavior HPB2, and the subevent SEB3 includes the high bandwidth transmission mode packet communication behavior HPB3 and the ACK signal transmission behavior RSB3.

It is appreciated that the embodiment described above uses the condition that the Bluetooth peripheral apparatus 120 operates in the normal transmission mode and the Bluetooth peripheral apparatus 130 operates in the high bandwidth transmission mode as an example. However, the behaviors arranged in the interlaced manner can be applied to various kinds of combinations of the transmission modes that the Bluetooth peripheral apparatus 120 and the Bluetooth peripheral apparatus 130 operate, e.g., in the combination that both of the apparatuses are operated in the high bandwidth transmission mode or a first one of the apparatuses operates in the normal transmission mode and a second one of the apparatuses operates in the high bandwidth transmission mode.

In an embodiment, the Bluetooth central apparatus 110 transmits a mode switching command MSC to the Bluetooth peripheral apparatus 120 and the Bluetooth peripheral apparatus 130 such that the Bluetooth peripheral apparatus 120 and the Bluetooth peripheral apparatus 130 receive the mode switching command MSC to either switch from the normal transmission mode to high bandwidth transmission mode or from the high bandwidth transmission mode to the normal transmission mode. In an embodiment, the mode switching command MSC can be transmitted in any subevent in the CIS interval of one CIS event or a control subevent additionally included. In another embodiment, the Bluetooth peripheral apparatus 120 and the Bluetooth peripheral apparatus 130 may be configured to operate in either the normal transmission mode or the high bandwidth transmission mode after being manufactured. The present invention is not limited thereto.

The Bluetooth peripheral apparatus and the Bluetooth central apparatus and having the dynamic bandwidth allocation mechanism of the present invention allow the Bluetooth peripheral apparatus that operates in a high bandwidth transmission mode to not perform the acknowledgement signal transmission behavior to increase the data bandwidth between the Bluetooth central apparatus and the Bluetooth peripheral apparatus so as to accomplish the object of the increasing the data transmission amount or the power saving.

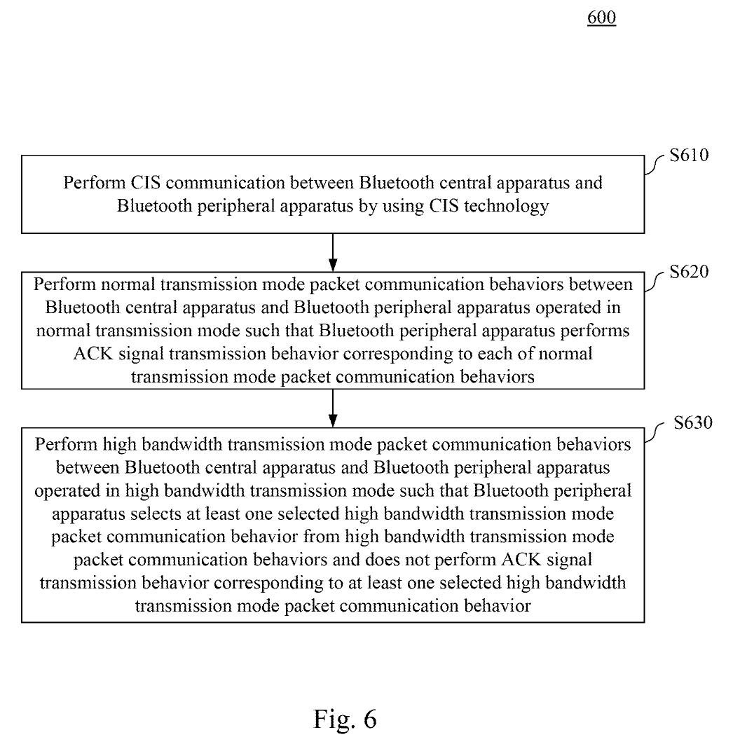

Reference is now made to FIG. 6. FIG. 6 illustrates a flow chart of a Bluetooth communication method 600 having a dynamic bandwidth allocation mechanism according to an embodiment of the present invention.

In addition to the apparatus described above, the present disclosure further provides the Bluetooth communication method 600 having the dynamic bandwidth allocation mechanism that can be used in such as, but not limited to, the Bluetooth central apparatus 110, the Bluetooth peripheral apparatus 120 and the Bluetooth peripheral apparatus 130 in FIG. 1. As illustrated in FIG. 6, an embodiment of the Bluetooth communication method 600 includes the following steps.

In step S610, the CIS communication is performed between the Bluetooth central apparatus 110 and the Bluetooth peripheral apparatus 120 (and/or the Bluetooth peripheral apparatus 130) by using the CIS technology.

In step S620, the normal transmission mode packet communication behaviors CPB1~CPB3 are performed between the Bluetooth central apparatus 110 and the Bluetooth peripheral apparatus (e.g., the Bluetooth peripheral apparatus 130) operated in the normal transmission mode such that the Bluetooth peripheral apparatus performs one of the ACK signal transmission behaviors RSB1~RSB3 corresponding to each of the normal transmission mode packet communication behaviors CPB1~CPB3.

In step S630, the high bandwidth transmission mode packet communication behaviors HPA1~HPA3 are performed between the Bluetooth central apparatus 110 and the Bluetooth peripheral apparatus (e.g., the Bluetooth peripheral apparatus 120) operated in the high bandwidth transmission mode such that the Bluetooth peripheral apparatus selects at least one selected high bandwidth transmission mode packet communication behavior (e.g., the high bandwidth transmission mode packet communication behaviors HPA1~HPA2) from the high bandwidth transmission mode packet communication behaviors HPA1~HPA3 and does not perform the ACK signal transmission behavior corresponding to the at least one selected high bandwidth transmission mode packet communication behavior.

It is appreciated that the embodiments described above are merely an example. In other embodiments, it should be appreciated that many modifications and changes may be made by those of ordinary skill in the art without departing, from the spirit of the disclosure.

For example, Bluetooth central apparatus may perform communication with a single Bluetooth peripheral apparatus communication or a composite Bluetooth peripheral apparatus communication that includes any number of sub-apparatuses and apply the dynamic bandwidth allocation mechanism thereto. The composite Bluetooth peripheral apparatus may be configured such that all the sub-apparatuses may operate in the high bandwidth transmission mode, or only a part of an arbitrary number of the sub-apparatuses operate in the high bandwidth transmission mode and another part of an arbitrary number of the sub-apparatuses operate in the normal transmission mode.

Further, the sub-apparatus that operates in the high bandwidth transmission mode may select any number of the high bandwidth transmission mode packet communication behaviors to be the selected high bandwidth transmission mode packet communication behaviors, and a part of the selected high bandwidth transmission mode packet communication behaviors may include a data amount that is larger than that of the normal transmission mode packet communication behaviors and another part of the selected high bandwidth transmission mode packet communication behaviors may include a data amount that equals to that of the normal transmission mode packet communication behaviors. The present invention is not limited to any numerical example described above.

In summary, the present invention discloses the Bluetooth peripheral apparatus, the Bluetooth central apparatus and the Bluetooth communication method having the dynamic bandwidth allocation mechanism allow the Bluetooth peripheral apparatus that operates in a high bandwidth transmission mode to not perform the acknowledgement signal transmission behavior to increase the data bandwidth between the Bluetooth central apparatus and the Bluetooth peripheral apparatus so as to accomplish the object of the increasing the data transmission amount or the power saving.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A Bluetooth peripheral apparatus having a dynamic bandwidth allocation mechanism comprising:
a communication circuit; and
a processing circuit electrically coupled to the communication circuit and configured to:
perform a connected isochronous stream (CIS) communication through the communication circuit with a Bluetooth central apparatus by using a CIS technology;
operate in a normal transmission mode to perform an acknowledgement (ACK) signal transmission behavior corresponding to each of a plurality of normal transmission mode packet communication behaviors performed with the Bluetooth central apparatus;
operate in a high bandwidth transmission mode to select at least one selected high bandwidth transmission mode packet communication behavior from a plurality of high bandwidth transmission mode packet communication behaviors performed with the Bluetooth central apparatus and not perform the ACK signal transmission behavior corresponding to the at least one selected high bandwidth transmission mode packet communication behavior.

2. The Bluetooth peripheral apparatus of claim 1, wherein the high bandwidth transmission mode packet communication behaviors correspond to a plurality of subevents in a CIS interval of a CIS event in a one-to-one manner.

3. The Bluetooth peripheral apparatus of claim 2, wherein the Bluetooth peripheral apparatus is one of a plurality of sub-apparatuses comprised by a composite Bluetooth peripheral apparatus to collectively perform the CIS communication with the Bluetooth central apparatus, wherein a first part of the sub-apparatuses operate in the high bandwidth transmission mode and a second part of the sub-apparatuses operate in either the high bandwidth transmission mode or the normal transmission mode.

4. The Bluetooth peripheral apparatus of claim 3, wherein the CIS events that the sub-apparatuses correspond to are arranged in a sequential manner.

5. The Bluetooth peripheral apparatus of claim 3, wherein the CIS events that the sub-apparatuses correspond to are arranged in an interleaved manner such that K-th subevents of the CIS intervals of all the sub-apparatuses are arranged in a sequential manner, and K+1 subevents of the CIS intervals of all the sub-apparatuses are arranged in a sequential manner behind the K-th subevents of the CIS intervals of all the sub-apparatuses, in which K is an integer larger than 0.

6. The Bluetooth peripheral apparatus of claim 1, wherein a first data amount comprised by each of the at least one selected high bandwidth transmission mode packet communication behavior is larger than a second data amount comprised by each of the normal transmission mode packet communication behaviors.

7. The Bluetooth peripheral apparatus of claim 1, wherein a first data amount comprised by each of the at least one selected high bandwidth transmission mode packet communication behavior equals to a second data amount comprised by each of the normal transmission mode packet communication behaviors.

8. The Bluetooth peripheral apparatus of claim 1, wherein the processing circuit is configured to receive a mode switching command from the Bluetooth central apparatus to either switch from the normal transmission mode to the high bandwidth transmission mode or from the high bandwidth transmission mode to the normal transmission mode.

9. A Bluetooth central apparatus having a dynamic bandwidth allocation mechanism, comprising:
a communication circuit; and
a processing circuit electrically coupled to the communication circuit and configured to:
perform a CIS communication through the communication circuit with a Bluetooth peripheral apparatus by using a CIS technology;
perform a plurality of normal transmission mode packet communication behaviors with the Bluetooth peripheral apparatus operated in a normal transmission mode to request the Bluetooth peripheral apparatus to perform an acknowledgement (ACK) signal transmission behavior corresponding to each of a plurality of normal transmission mode packet communication behaviors; and
perform a plurality of high bandwidth transmission mode packet communication behaviors with the Bluetooth peripheral apparatus operated in a high bandwidth transmission mode to select at least one selected high bandwidth transmission mode packet communication behavior from a plurality of high bandwidth transmission mode packet communication behaviors to stop requesting the Bluetooth peripheral apparatus to perform the ACK signal transmission behavior corresponding to the at least one selected high bandwidth transmission mode packet communication behavior.

10. The Bluetooth central apparatus of claim 9, wherein the high bandwidth transmission mode packet communication behaviors correspond to a plurality of subevents in a CIS interval of a CIS event in a one-to-one manner.

11. The Bluetooth central apparatus of claim 10, the Bluetooth peripheral apparatus is one of a plurality of sub-apparatuses comprised by a composite Bluetooth peripheral apparatus and the Bluetooth central apparatus performs the CIS communication with the sub-apparatuses, wherein a first part of the sub-apparatuses operate in the high bandwidth transmission mode and a second part of the sub-apparatuses operate in either the high bandwidth transmission mode or the normal transmission mode.

12. The Bluetooth central apparatus of claim 11, wherein the CIS events that the sub-apparatuses correspond to are arranged in a sequential manner.

13. The Bluetooth central apparatus of claim 11, wherein the CIS events that the sub-apparatuses correspond to are arranged in an interleaved manner such that K-th subevents of the CIS intervals of all the sub-apparatuses are arranged in a sequential manner, and K+1 subevents of the CIS intervals of all the sub-apparatuses are arranged in a sequential manner behind the K-th subevents of the CIS intervals of all the sub-apparatuses, in which K is an integer larger than 0.

14. The Bluetooth central apparatus of claim 9, wherein a first data amount comprised by each of the at least one selected high bandwidth transmission mode packet communication behavior is larger than a second data amount comprised by each of the normal transmission mode packet communication behaviors.

15. The Bluetooth central apparatus of claim 9, wherein a first data amount comprised by each of the at least one selected high bandwidth transmission mode packet communication behavior equals to a second data amount comprised by each of the normal transmission mode packet communication behaviors.

16. The Bluetooth central apparatus of claim 9, wherein the processing circuit is configured to transmit a mode switching command to the Bluetooth peripheral apparatus to either switch the Bluetooth peripheral apparatus from the normal transmission mode to the high bandwidth transmission mode or from the high bandwidth transmission mode to the normal transmission mode.

17. A Bluetooth communication method having a dynamic bandwidth allocation mechanism, comprising:
performing a CIS communication between a Bluetooth central apparatus and a Bluetooth peripheral apparatus by using a CIS technology;
performing a plurality of normal transmission mode packet communication behaviors between the Bluetooth central apparatus and the Bluetooth peripheral apparatus operated in a normal transmission mode such that the Bluetooth peripheral apparatus performs an acknowledgement (ACK) signal transmission behavior corresponding to each of the normal transmission mode packet communication behaviors; and
performing a plurality of high bandwidth transmission mode packet communication behaviors between the Bluetooth central apparatus and the Bluetooth peripheral apparatus operated in a high bandwidth transmission mode such that the Bluetooth peripheral apparatus selects at least one selected high bandwidth transmission mode packet communication behavior from the high bandwidth transmission mode packet communication behaviors and does not perform the ACK signal transmission behavior corresponding to the at least one selected high bandwidth transmission mode packet communication behavior.

18. The Bluetooth communication method of claim 17, wherein the high bandwidth transmission mode packet communication behaviors correspond to a plurality of subevents in a CIS interval of a CIS event in a one-to-one manner.

19. The Bluetooth communication method of claim 18, further comprising:
transmitting a mode switching command by the Bluetooth central apparatus to the Bluetooth peripheral apparatus to either switch the Bluetooth peripheral apparatus from the normal transmission mode to the high bandwidth transmission mode or from the high bandwidth transmission mode to the normal transmission mode.

20. The Bluetooth communication method of claim 18, the Bluetooth peripheral apparatus is one of a plurality of sub-apparatuses comprised by a composite Bluetooth peripheral apparatus to collectively performs the CIS communication with the Bluetooth central apparatus, wherein a first part of the sub-apparatuses operate in the high bandwidth transmission mode and a second part of the sub-apparatuses operate in either the high bandwidth transmission mode or the normal transmission mode.
